(19) United States
(12) Patent Application Publication
(10) Pub. No.: US 2003/0120491 A1
(43) Pub. Date: Jun. 26, 2003

(54) Text to speech apparatus and method and information providing system using the same

(75) Inventor: Kazumi Naoi, Kanagawa (JP)

Correspondence Address: McDERMOTT, WILL & EMERY, 600 13th Street, N.W., Washington, DC, 20005-3096, US

(73) Assignee: NISSAN MOTOR CO., LTD.

(21) Appl. No.: 10/323,998

(22) Filed: Dec. 20, 2002

(30) Foreign Application Priority Data
Dec. 21, 2001 (JP) 2001-389894

(51) Int. Cl. G10L 13/08

(52) U.S. Cl. 704/260

(57) ABSTRACT

In a text to speech apparatus and method and information providing system, a plurality of defined clause patterns are stored in a first memory section in an information providing system, a plurality of speech prosody patterns are stored in a second memory section in an information terminal such as an in-vehicle information terminal, each speech prosody pattern being preset to correspond to one of the defined clause patterns and to reproduce the corresponding one of the defined clause patterns in a natural intonation speech sound, and a text speech section carries out a read out of at least one text sentence in accordance with one of the speech prosody patterns which corresponds to one of the defined clause patterns when at least the one of the defined clause patterns is present in the text sentence to be read out.

### BACKGROUND OF THE INVENTION

(1) Field of the Invention

The present invention relates to a text to speech (abbreviated as TTS) apparatus and method which convert a text sentence into a speech sound to read out the converted text contents and an information providing system using the text to speech apparatus and method described above.

(2) Description of the Related Art

In a previously proposed information providing system in which an information is transmitted from an information center to an in-vehicle information terminal, the in-vehicle information terminal providing the information for a user. A document is transmitted as a text data from the information center and, in the in-vehicle information terminal, a previously proposed text to speech apparatus has been used which converts the text data into a speech data to read out the text data.

### SUMMARY OF THE INVENTION

However, the previously proposed text to speech apparatus has resulted in a speech without intonation when the text document is read out in the speech sound. In order to achieve an approximately natural intonation speech sound, a performance of the TTS apparatus needs to be increased but it requires a lot of costs to improve the performance.

It is, hence, an object of the present invention to provide an improved text to speech (TTS) apparatus and method and an information providing system using the improved text to speech (TTS) apparatus and method which can achieve the text read out in a substantially natural intonation speech sound with least possible cost.

According to one aspect of the present invention, there is provided a text to speech apparatus, comprising; a first memory section in which a plurality of defined clause patterns are stored; a second memory section in which a plurality of speech prosody patterns are stored, each speech prosody pattern being preset to correspond to one of the defined clause patterns and to reproduce the corresponding one of the defined clause patterns in a natural intonation speech sound; and a text speech section that carries out a read out of at least one text sentence in accordance with one of the speech prosody patterns which corresponds to one of the defined clause patterns when at least the one of the defined clause patterns is present in the text sentence to be read out.

According to another aspect of the present invention, there is provided an information providing system comprising: an information center that transmits various information including at least one text sentence to be read out, the information center including a first memory section in which a plurality of defined clause patterns are stored and specifying one of the defined clause patterns stored in the first memory section in a case where at least the one of the defined clause patterns is included in the text sentence to be read out; and at least one information terminal that receives the various information including the text sentence from the information terminal, the information terminal including: a second memory section in which a plurality of speech prosody patterns are stored, each speech prosody pattern being preset to correspond to one of the defined clause patterns and to reproduce the corresponding one of the defined clause patterns in a natural intonation speech sound; and a text speech section that carries out a read out of at least one text sentence in accordance with one of the speech prosody patterns when at least the one of the defined clause patterns is present in the text sentence received therein to be read out.

According to a still another aspect of the present invention, there is provided a text to speech method, comprising; storing a plurality of defined clause patterns; storing a plurality of speech prosody patterns, each speech prosody pattern being preset to correspond to one of the defined clause patterns and to reproduce the corresponding one of the defined clause patterns in a natural intonation speech sound; and carrying out a read out of at least one text sentence in accordance with one of the speech prosody patterns which corresponds to one of the defined clause patterns when at least the one of the defined clause patterns is present in the text sentence to be read out.

This summary of the invention does not necessarily describe all necessary features so that the invention may also be a sub-combination of these described features.

### BRIEF DESCRIPTION OF THE DRAWINGS

FIG. 1 is a circuit block diagram representing an information providing system in a preferred embodiment to which a text to speech (TTS) apparatus and method in a preferred embodiment according to the present invention is applicable.

FIG. 2 is a table representing examples of clause patterns expressing route line names and their directions of a traffic information used in the information providing system shown in FIG. 1.

FIG. 3 is a table representing examples of clause patterns expressing congestions and regulations of the traffic information used in the information providing system shown in FIG. 1.

FIG. 4 is a table representing an example of a common fixed clause pattern of the traffic information.

FIGS. 5A, 5B, and 5C are tables representing examples of speech contents on the traffic information.

FIG. 6 is a table representing an example of a clause pattern of a weather forecast.

FIG. 7 is a table representing an example of the clause pattern expressing a probability of precipitation in the weather forecast.

FIG. 8 is a table representing an example of a fixed clause pattern of the weather forecast.

FIGS. 9A and 9B is a table representing an example of speech contents on the weather forecast.

FIG. 10 is an explanatory view representing a format of a read out text file to be transmitted from an information center shown in FIG. 1.

FIGS. 11A, 11B, 11, 11D, 11E, 11F, and 11G are tables representing speech contents to be transmitted from the information center to an in-vehicle information terminal shown in FIG. 1.

FIG. 12 is an operational flowchart representing an information providing operation between the information center and the in-vehicle information terminal shown in FIG. 1.

FIG. 13 is a subroutine executed at a step S5 of FIG. 12 on an information reproduction of an NPM corresponding text.

### DETAILED DESCRIPTION OF THE PREFERRED EMBODIMENT

Reference will hereinafter be made to the drawings in order to facilitate a better understanding of the present invention.

Described bereinbelow is a preferred embodiment of a text to speech (TTS) apparatus according to the present invention which is applicable to a vehicular information providing system in which various information from an information center is transmitted to an in-vehicle information terminal is transmitted and the information is provided from the in-vehicle information terminal to a user. It is noted that the present invention is not limited to a vehicular information providing system but is applicable to every information providing system. For example, the text to speech (TTS) apparatus according to the present invention can be applied to a PDA (Personal Digital Assistant) or a mobile personal computer. Thus, a text voice read out (text speech) in a natural intonation can be achieved. The present invention is also applicable to an information terminal which serves as both in-vehicle information terminal and portable information terminal (or PDA). This in-vehicle and portable compatible information terminal can be used as the in-vehicle information terminal with the terminal set on a predetermined location and as the Personal Digital Assistant (PDA) if the in-vehicle information terminal is taken out from the predetermined location of the vehicle and is carried.

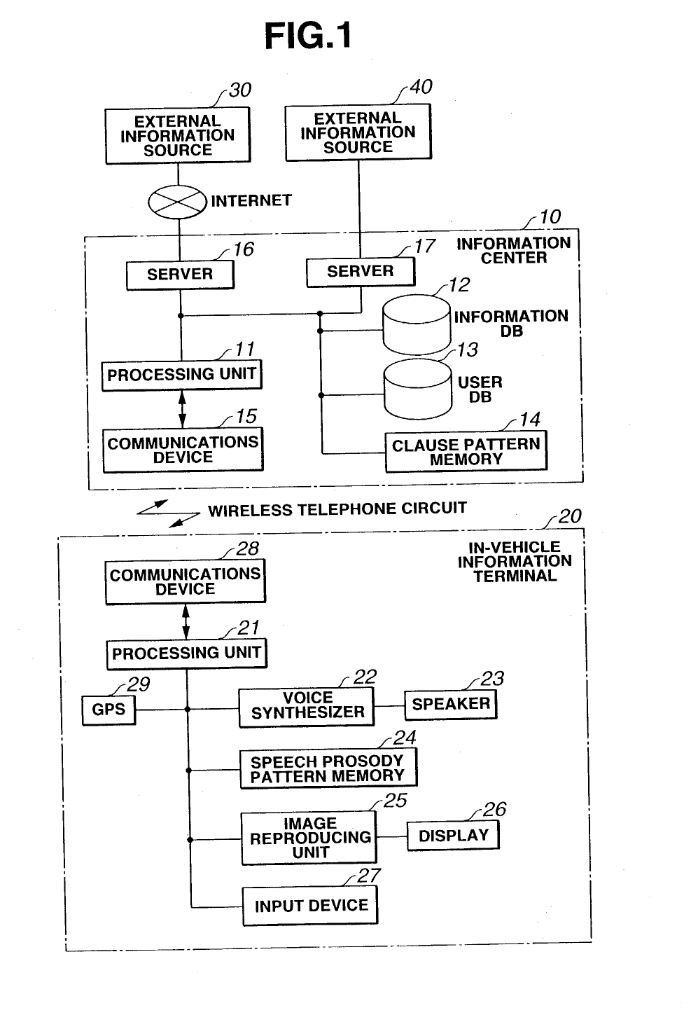

FIG. 1 shows a rough configuration of the preferred embodiment of the TTS apparatus described above. The vehicular information providing system in which the text to speech apparatus in the embodiment is mounted is constituted by information center 10 and in-vehicle information terminal 20. It is noted that although, only one set of in-vehicle information terminal 20 is shown in FIG. 1, a plurality of the same in-vehicle information terminals are installed in many automotive vehicles. It is also noted that the information center 10 and the in-vehicle information terminal 20 are communicated via a wireless telephone circuit.

Information center 10 includes: a processing unit 11 for implementing an information processing; information data base (DB) 12 storing various information contents; a user database 13 (DB) storing a user information; a clause pattern memory 14 storing clause patterns for a text document; and a communications device 15 to perform communications to in-vehicle information terminal 20 via a wireless telephone circuit. Information center 10 further includes a server 16 to input the information from an external information source 30 via an internet; and a server 17 which directly inputs a road traffic information and a weather information from such an external information source 40 such as a public road traffic information center and the Meteorological agency.

On the other hand, in-vehicle information terminal 20 includes; a processing unit 21 inputting the information from the information center 10 and reproducing the inputted information from information center 10; a voice synthesizer 22 which converts a text document into a speech (voice) to drive a speaker 23; a speech prosody pattern memory 23 storing speech prosody patterns, each corresponding to one of the defined clause patterns; an image reproducing unit 25 which generates an image data, reproduces the generated image data, and displays the image data on a display 26; an input device 27 having an operation member such as a switch; a communications device 28 to perform communications with the information center 10 via a GPS (Global Positioning System) receiver 29 which detects a present position of an automotive vehicle in which the in-vehicle information terminal 20 is mounted.

Then, voice synthesizer 22 converts the text (document) into speech (TTS: Text to Speech) according to a speech synthesizing method called generally an NPN (Natural Prosody Mapping) as will be described later. It is noted that, in this specification, the text (document or sentence) is read out in a speech sound (or voice form) in accordance with the speech prosody pattern is called NPM (Natural Prosody Mapping) corresponding text read out. Text file, text sentence, and a clause block, which perform a text vocal read out corresponding to NPM are called NPM corresponding text file, NPM corresponding text sentence, and NPM corresponding clause block, respectively. On the other hand, a previously proposed text read out in which the speech prosody pattern is not used is called NPM corresponding text read out. The text file, the text document, and clause block which performs the text read out not corresponding to NPM are called NPM non-corresponding text file, NPM non-corresponding text sentence, and NPM non-corresponding clause block.

Next, a text read out method carried out in the TTS apparatus in this embodiment will be described below.

That is to say, a writing expressing a speech content such as a traffic information or weather forecast is analyzed. One or more of clauses, for example, whose frequencies in use are comparatively high, are extracted from the sentence to define a clause pattern(s). Then, the speech contents are constituted by combining a plurality of clause patterns including undefined clause patterns. In addition, speech prosody patterns are preset and stored in order to reproduce and speak the defined respective clause patterns in substantially a natural intonation. Then, when the speech contents including the text sentence to be read out in the vocal form are transmitted from information center 10, the number of the defined clause patterns used in the read out text sentence is specified. At the in-vehicle information terminal 20, the text sentence is read out in the vocal form in accordance with the speech prosody pattern corresponding to the specified number indicating the required clause pattern. Thus, the text read out in the natural intonation with a least possible cost can be achieved. It is noted that the clause pattern to be stored in the clause pattern memory section 14 in is not limited to the clause having the high frequency in use. For example, such a cause as to become unnatural intonation when the text read out in the vocal form is carried out or such a voice as to be inaudible may be patternized in the defined clause pattern.

Extraction and definition of the clause pattern in the speech content such as the road traffic information and weather forecast information are carried out as follows: For example, suppose such weather forecasts as “the probability of precipitation (rain) is 10 percents” and “the probability of precipitation (rain) is 100 percents ”. The clause pattern to be stored in clause pattern memory 14 is constituted by a variable phrase which can be replaced with an arbitrary phrase of “10” and “100” and a common fixed phrase other than the variable phrases.

In addition, suppose such traffic congestion information as “The traffic is congested by 3.5 kilometers at the neighborhood of Yoga Toll Gate” and “The traffic is congested by 5 kilometers at Tanimachi Junction”. The clause pattern can be said to be constituted by the variable phrase replaceable with each arbitrary phrase such as “neighborhood of Yoga Toll Gate”, “Tanimachi junction”, “3.0”, and “5” and the common fixed phrase other than the variable phrases.

Hereinbelow, one example of clause patterns of the speech contents such as traffic information and weather forecast will be described below.

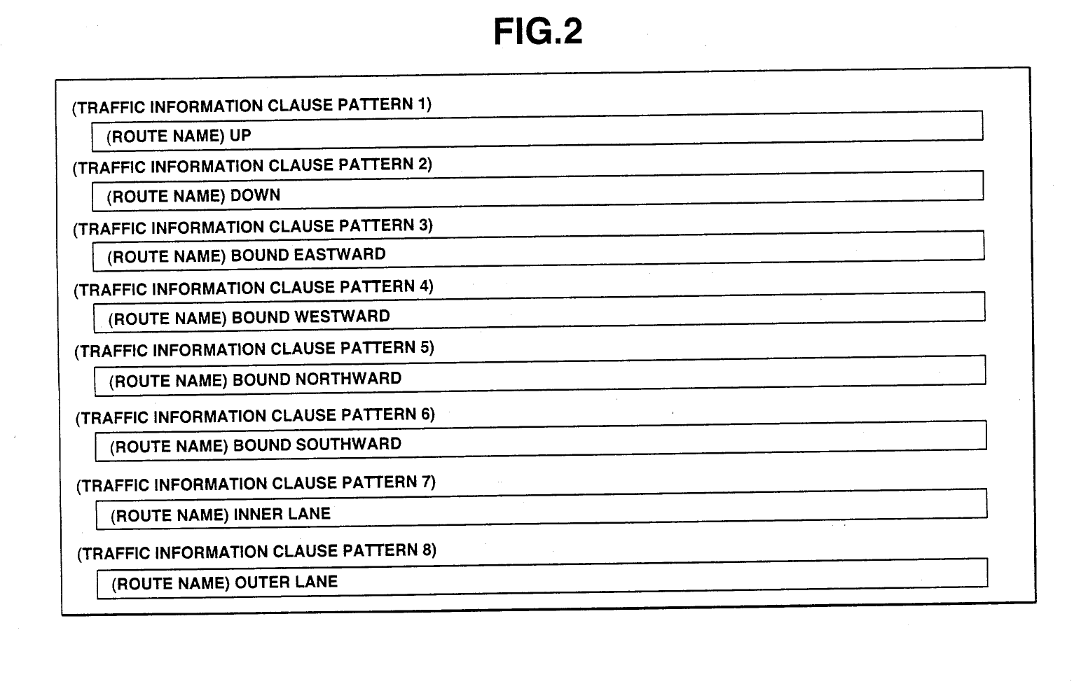

The clauses expressing routes and directions on the traffic information may be considered to have such patterns as “Tomei Expressway up”, “Tomei Expressway down”, “Keiyo Doro (or Keiyo Expressway) down”, “Wangan (Tokyo Bay) line bound eastward”, “Wangan (Tokyo Bay) line bound westward”, “Inner lines of a Center Loop line”, and “Outer lines of a Center Loop line”. For these patterns, traffic information clause patterns 1 through 8, are defined as shown by FIG. 2.

It is noted, as appreciated from FIG. 2, that the phrases enclosed by brackets are variable phrases replaceable with arbitrary phrases enclosed by brackets are variable phrases replaceable with arbitrary phrases and those not enclosed by the brackets are fixed phrases. (Hereinafter, these rules are applied equally well to other clause patterns).

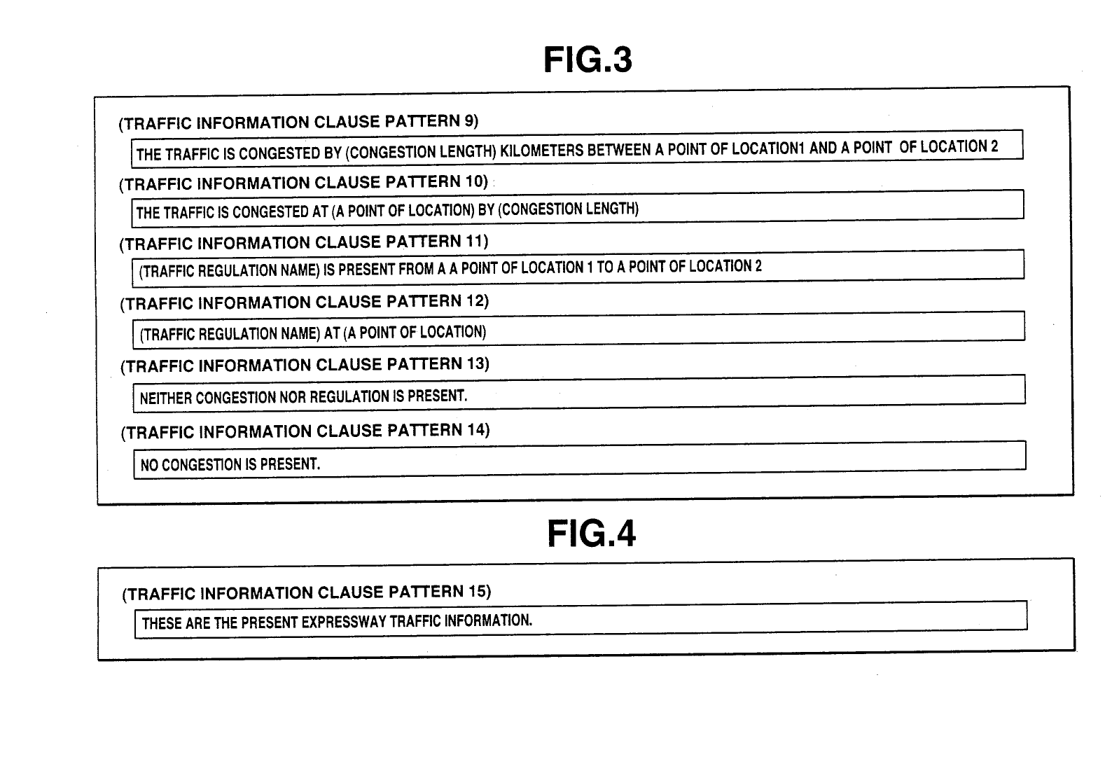

In addition, the clauses expressing traffic congestions and regulations may have such problems as “The traffic is congested by 3.0 Km between Yoga and Tanimachi”. “The traffic is congested at Yoga”. “Closed to the traffic is between Yogi and Tanimachi”, “Closed to the traffic is at Yoga”, “Neither congestion nor regulation is present”, and “No congestion is present”. From these clause patterns, the traffic information clause patterns No. 9 through No. 14 shown in FIG. 3 are defined.

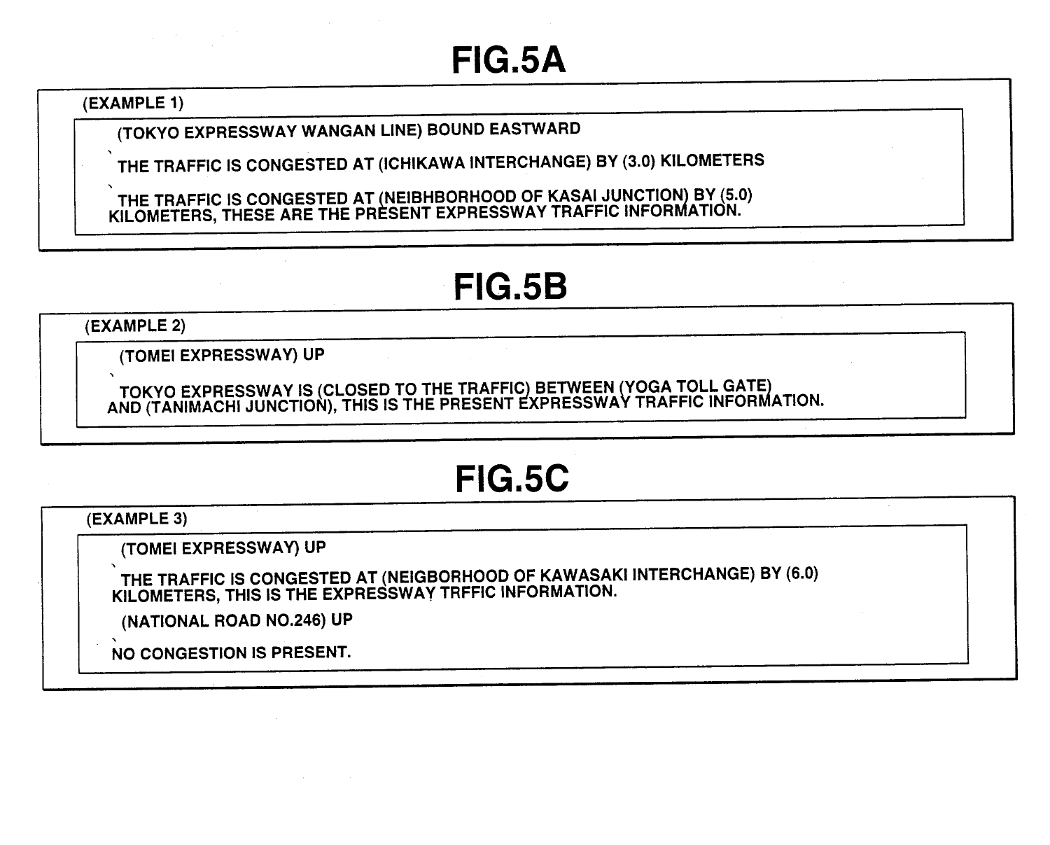

Furthermore, an example of the fixed phrase shown in FIG. 4 when the traffic information is expressed is defined as traffic information clause pattern No. 15. In FIG. 4, in Japanese, “to natte orimasu∘”. This fixed clause is, for example, translated as “THESE ARE THE PRESENT EXPRESSWAY TRAFFIC INFORMATION.” As described above, using traffic information clause patterns No. 1 through No. 15, such speech contents of the traffic information as shown in FIGS. 5A, 5B, and 5C can be architected. In Example 1 of FIG. 5A, the translation shown in FIG. 5A is carried out from the clause patterns starting from (Syuto kou Wangan Sen) Higashi Yuki, (Ichikawa Interchange) De Jyuutai (3.0) Kilometers, (Kasai Junction Fikin) De Jyuutai (5.0) Kilometer and ended at to natte imasu∘. It is noted that a punctuation mark of ∘ is generally equal to a period of “.” and another punctuation mark of, is generally equal to a comma of, or a word of “and”. FIG. 5B, the translation shown in FIG. 5B is carried out from the clause patterns starting from (Tomei Kosoku Doro) Nobori, (Yoga Ryokinsho) Kara (Tanimachi Junction) No Aidade (Tsukodome) and ended at the phrase of to natte imasu∘. In Example 3 in FIG. 5C, the translation shown in FIG. 5C us carried out from the clause pattern starting from (Tomei Kosoku Doro) Nobori, (Kawasaki Interchange Fikin) De Jyutai (6.0) Kilometers to natte imasu∘

(Kokudo 246 Go Sen) Nobori, and ended at Jyutai Ha Arimasen∘.

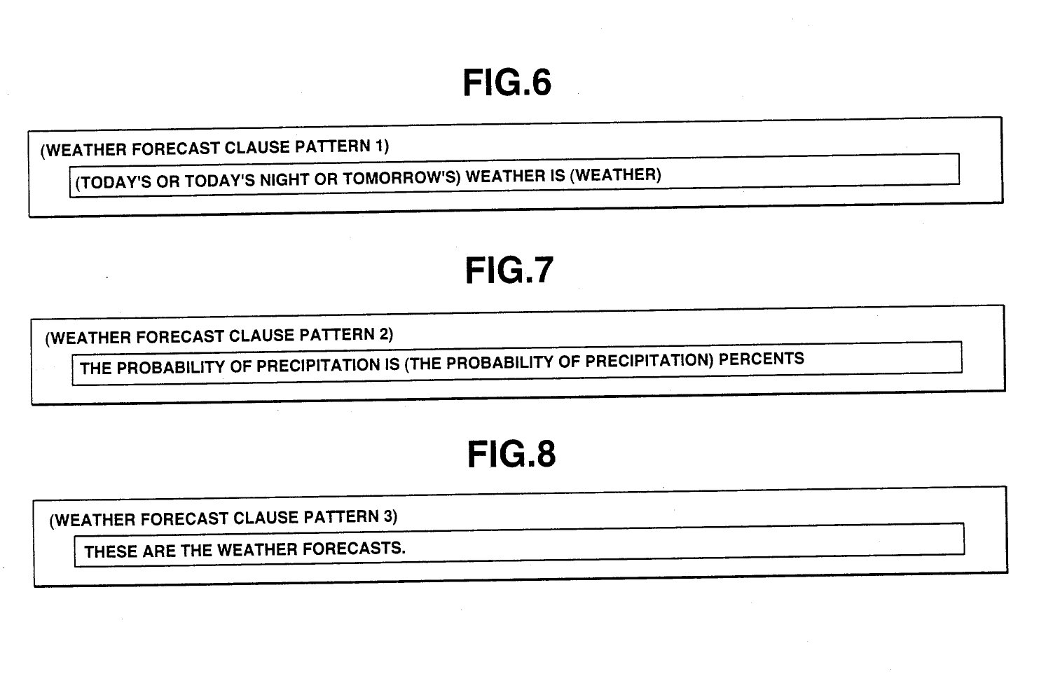

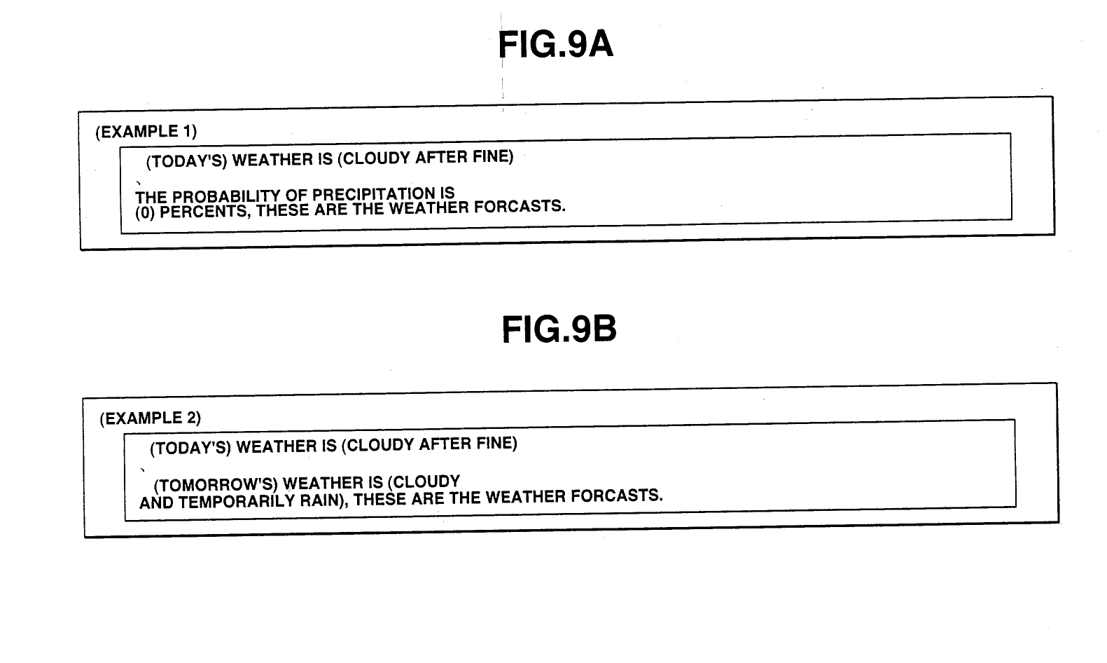

Next, the clauses expressing (regional or national) weathers on the weather forecast may be considered as follows: “Today's weather is fine”, “Today's weather is cloudy”, “Today's weather is cloudy”, “Today's weather is fine after cloudy”, “Today's weather is fine after cloudy”, “Today's weather is fine after cloudy”, “Today's night weather is rain”, “Today's night weather is fine”, “Tomorrow's weather is fine after cloudy”, and “Tomorrow's weather is snow after cloudy”. From these patterns, weather forecast clause pattern 1 as shown in FIG. 6 is defined. In addition, the clauses expressing the probability of precipitation (rain) may be considered as follows: “The probability of precipitation is 0 percents.”, “The probability of precipitation is 10 percents.”, and “The probability of precipitation is 100 percents.”. From these patterns, the weather forecast clause pattern 2 shown in FIG. 7 is defined. Using the above-described weather forecast clause patterns 1 through 3 are used so that the speech content of the weather forecast as shown in FIGS. 9A and 9B can be structured. The translation of FIG. 9A is carried out from an original Japanese sentence as follows: (Kyo) No Tenki Ha (Hare Nochi Kumori), Kousui Kakuritsu Ha (0) Percent No Yoso Desu∘. The translation of FIG. 9B is carried out from an original Japanese sentence as follows: (Kyono) Denki Ha (Hare Nochi Kumori), Asu No Tenki Ha (Kumori Ichizi Ame) No Yoso Desu∘.

The clause patterns thus defined as described above are stored into clause pattern memory 14 of information center 10 and the speech prosody pattern corresponding to each clause pattern stored therein is stored into speech prosody pattern memory 24 of the in-vehicle information terminal 20. The speech prosody pattern is a pattern to read out in the vocal form (speech sound) the text of the corresponding clause pattern in the natural intonation. Processing unit 11 of information center 10 generates such speech contents as the traffic information, the weather forecast, and the seasonal information (cherry blossom in full bloom information, information on the best time to see read leaves of autumn, and a ski ground condition information).

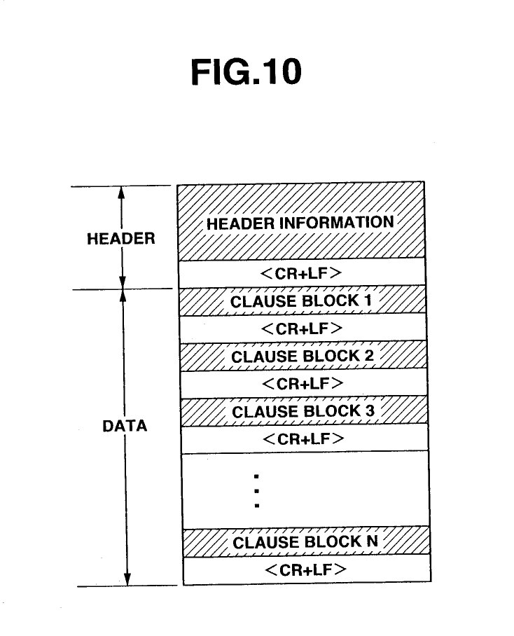

The speech contents are generated as a vocal read out (or speech) text file in accordance with the following format. FIG. 10 shows a construction of the vocal read out text file is constituted by a header (portion) and a data (portion). The header describes a header tag (#!npm) representing that the text file is the NPM corresponding vocal read out text and its property information (which can be omitted). The property information includes a version information and the information representing that it is NPM correspondence or NPM non-correspondence. The version information is described as (version=“1.00”). The NPM corresponding text is described as (npm=1). The NPM non-corresponding text is described as (npm=0). CR+LF>new line is set between the header and the data.

In-vehicle information terminal 20 handles the text file of the speech contents transmitted from information center 10 as NPM non-corresponding read out text sentence if there is no description of the header tag (#! npm) on the text file described above. On the other hand, in a case where there is a description of the header tag (#! npm) in the text file of the speech contents transmitted from information center 10 and no description about the property information or in a case where there is the description of the header tag (#! npm) and the description of the property information (npm=1) in the text file of the speech contents transmitted from information center 10, the text file of the speech contents described above is handled as the NPM corresponding read out (speech) text sentence. In a case where there is such a description as (npm=0) in the property information even in a case where there is the description of the header tag (#!npm) in the text file described above is treated as the NPM non-corresponding read out (speech) text sentence. On the other hand, the data portion is constituted by a plurality of clause blocks, <CR+LF>new line being interposed between each clause block. In addition, the clause tag, the property information, and clause data are described on each clause block. The clause tag is described at a head of each clause block. The clause tag is described at a head of each clause block. In the case of NPM corresponding clause block tag (#npm) is set as the clause tag. In-vehicle information terminal 20 reproduces sequentially the plurality of clause blocks of the data portion from an upward portion. If the NPM corresponding clause tag (#npm) is described on the head of the corresponding clause block, the corresponding clause block is handled as the NPM corresponding clause block. The vocal read out corresponding to NPM for the corresponding clause data is carried out. It is noted that, in a case where NPM corresponding clause tag (#npm) is not described on the head of the clause block, the corresponding clause block is handled as the NPM non-corresponding clause block and the vocal read out which does not corresponds to NPM is carried out. The property information in the clause block is described in such a form that the defined clause pattern number N is (pattern=N). Voice synthesizer 22 of in-vehicle information terminal 20 reads the speech prosody pattern corresponding to the clause pattern number N from a speech prosody pattern memory 24 and carries out the vocal read out of the clause data in accordance with the speech prosody pattern.

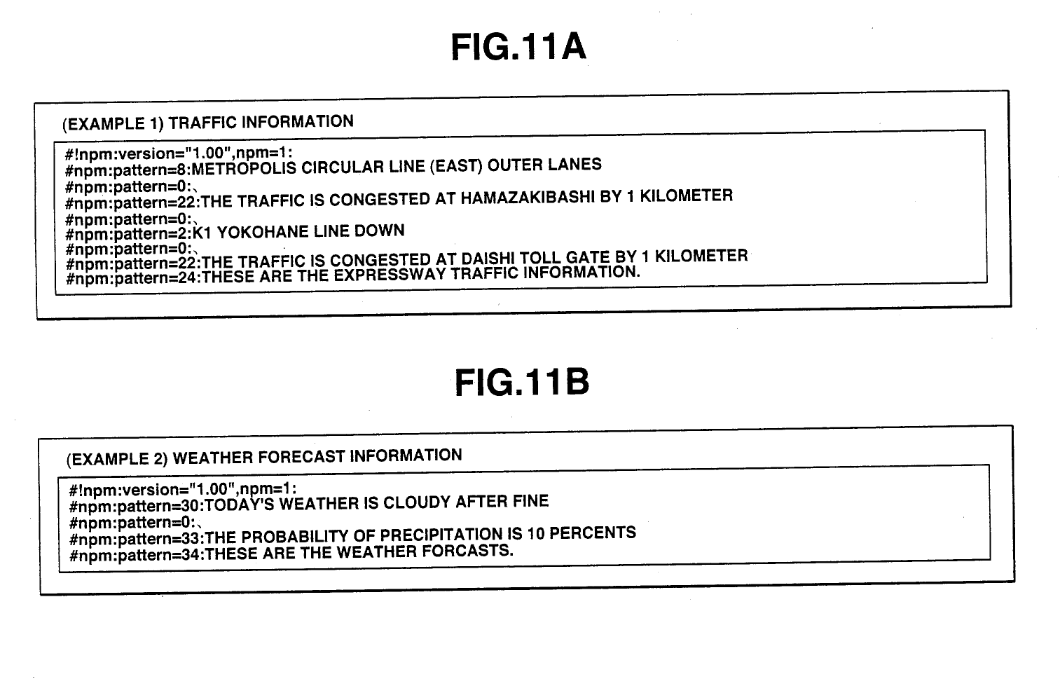

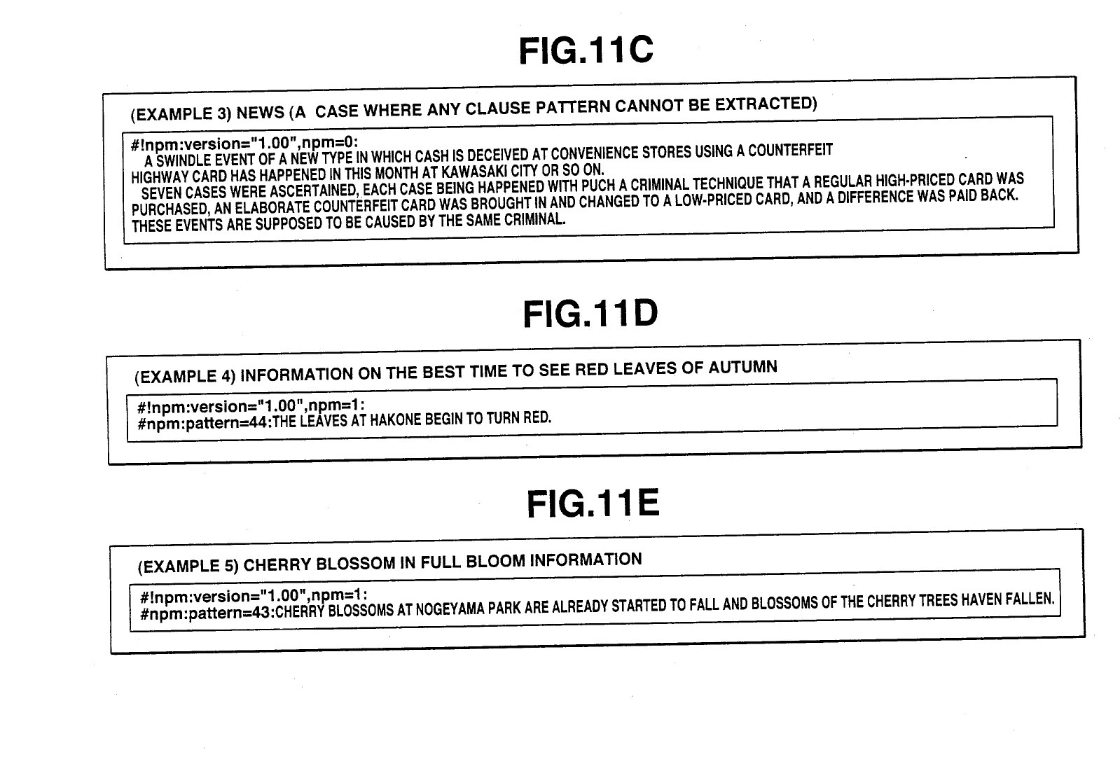

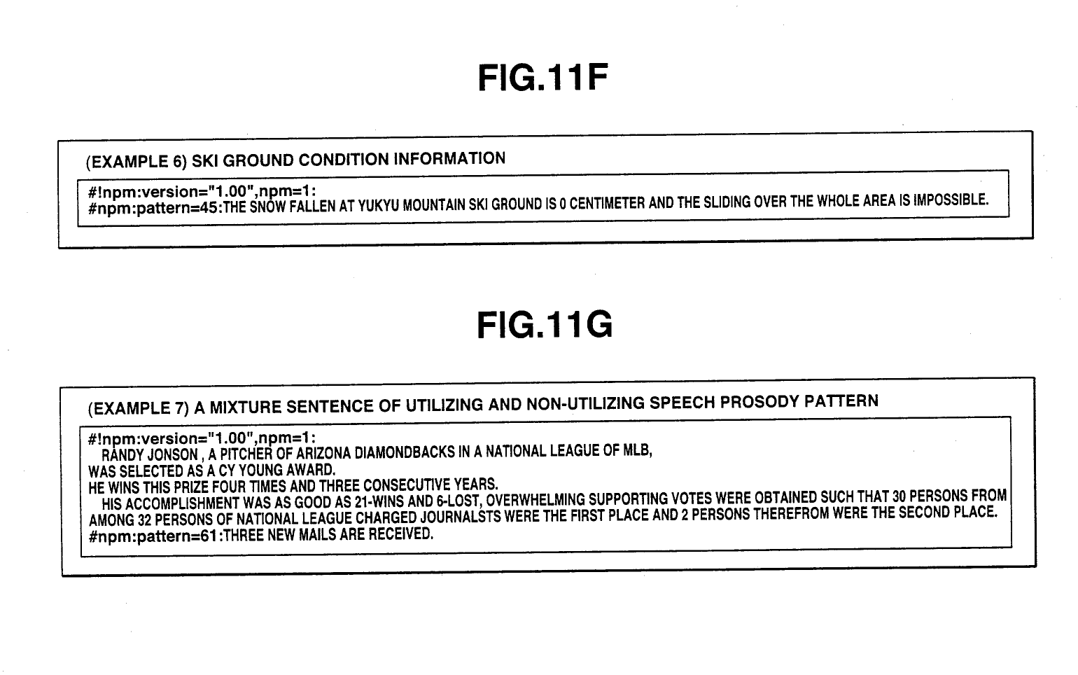

FIGS. 11A through 11G show examples of the speech contents transmitted from information center 10 to in-vehicle information terminal 20. FIG. 11A shows an example 1 of the traffic information related speech content. That is to say, the translation of Japanese clauses is shown in FIG. 11A as follows:

#!npm:version=“1.00”, npm=1: (First line is blank)

#!npm:pattern=8: Toshin Kanjyo Sen (Higashi) Sotomawari

#npm:pattern=0;

#npm:pattern=22: Hamasakibashi De Jyutai 1 Kilometer

#npm:pattern=0:,

#npm:pattern=2: K1 Go Yokohane Sen kudari

#npm:pattern=0:,

#npm:pattern=22:TaishiYoukinsho De Jyutai 1 Kilometer

#npm:pattern=24: To Natte Imasu∘

FIG. 11B shows an example 2 of the weather forecast information in some area. That is to say, the translation of Japanese clauses is shown in FIG. 11B as follows:

#!npm:version=“1.00”, npm=1: (blank)

#npm:pattern=30:Kyou No Tenki Ha Hare Nochi Kumori

#npm:pattern=0;,

#npm:pattern=30: Kyo No Tenki Ha Hare Nochi Kumori

#npm:pattern=0:,

#npm:pattern=33:Kousuikakuritsu Ha 10 Percent

#npm:pattern=34: No Yoso Desu∘

FIG. 11C shows an example 3 of the news from which no clause pattern can be extracted. That is to say, the translation of Japanese clauses described herein in FIG. 11C as follows:

#!npm:version=“1.00”,npm=1: (blank)

GizoHaiWayCard Wo Tsukai Konbini De Genkin Wo Damashi Toru Sinte No Sagi Ziken Ga Kongetsu, Kawasaki Sinai Nadode Hassei Siteimasu∘

Seiki No Kogaku Kard Wo Kounyu, Seiko Na Gizou Ka-do Wo Mochikinde Teigaku Wo Harai Modosu Teguchi De 7 Ken Ga Hanmei. DoitsuHannin No Shiwaza.

FIG. 11D shows an example 4 of the information of the best time to see red leaves of autumn.

That is to say, the translation of Japanese clauses are described as follows:

#!npm:version=“1.00”, npm=1;

#npm:pattern=44: Koyo at Hakone are Irozuki Hazime Teorimasu∘

FIG. 11E shows an example 5 of the information of cherry blossom in full bloom information.

That is to say, the translation of Japanese clauses are described as follows:

#!npm:vision=“1.00”, npm=1: (blank)

#npm: pattern=43: Nogeyama Koen No Sakura Ha Mo Chirihazimekara Hazakura Desu.

FIG. 11F shows an example 6 of the information of a Ski Ground condition information.

That is to say, the translation is A ski Ground Information. That is to say, the translation of the Japanese clause are as follows:

#!npm:version=“1.00”,npm=1:

Amerika Dai League, National League No Cy Young Sho Ni Daiyamondobakkusu NO Randy Jhonson Toshu Ga Erabaremashita. 3 Nen Renzoku 4 Dome No Zyusho Desu∘

21 Sho 6 Pai No Kouseiseki De, National Riigu Tanto Kisha 32 Nin Chyu, 30 Nin Ga 1 I, 2 Ri Ga 2 I To Attoutekina Shizi Wo Kakutoku Simasita∘

#npm: pattern=61 ShinChaku Meiru Ga 3 Ken Todoiteimasu∘.

In these Examples 1 and 2 described in FIGS. 11A and 11B, at least one such punctuation marks as “,” which requires no vocal read out (no speech) is included. In the property information of the corresponding clause pattern, (pattern=0) is described representing that this is undefined clause pattern. In addition, FIG. 11C shows an example (Example 3) of the speech content of the news from which any clause pattern cannot be extracted. It is noted that (npm=0) representing that this is the text file which does not correspond to NPM is described in the property information of the header portion in Example 3. FIG. 11D shows an example (Example 4) of the speech content of the information on the best time to see red leaves of autumn. FIG. 11E shows an example (Example 3) of the speech content of the information on a gloom state of cherry blossoms. FIG. 11F shows an example (Example 6) of the speech content of a ski ground condition. Furthermore, FIG. 11G shows an example of the speech content in which NPM non-corresponding clauses (lines 2 through 6 in FIG. 11G) are present.

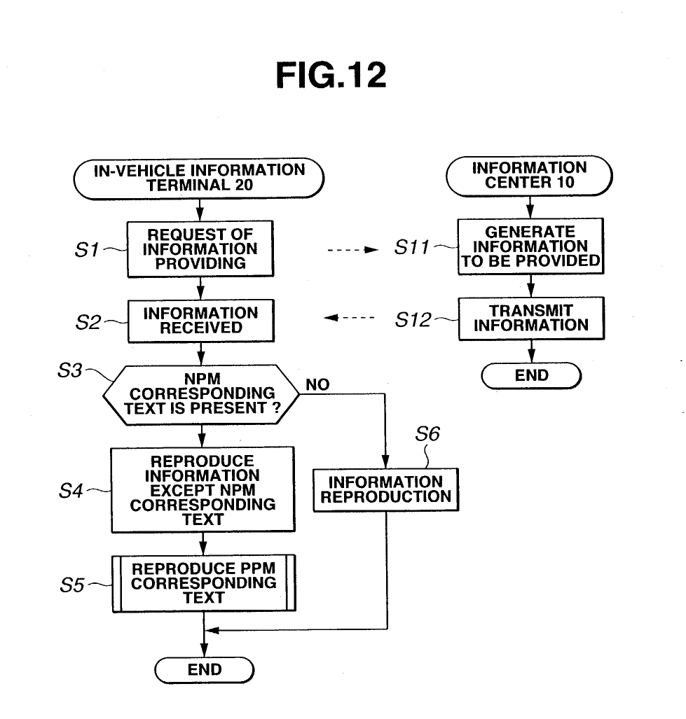

FIG. 12 shows an operational flowchart representing an information providing operation between information center 10 and in-vehicle information terminal 20. When an information providing request operation is carried out in response to an indication of input device 27 of the in-vehicle information terminal 20, this information providing operation is started. It is noted that the information providing operation is activated in response not limited to the request operation through input device 27 but also include a case where a previously distribution contacted information is automatically provided from information center 10. In-vehicle information terminal 20, at a step S1, the information providing request is transmitted to information center 10. The information providing request includes a kind of information, the content thereof, a code to identify the user, a mobile phone number, and the present location.

Information center 10 receives the information providing request from in-vehicle information terminal 20 at a step S11 and collates with a user data stored in user data base 13 to confirm the information providing contract. If an information providing requesting person is a contractor, information center 20 reads the information contents from information data base 12 in accordance with request contents, inputs the information from the information data base 30 in accordance with the request contents, inputs the road traffic information and the weather information to generate the provided information contents. At a step S12, information center 10 transmits the information contents to in-vehicle information terminal 20.

In-vehicle information terminal 20 receives the information contents from information center 10 at a step S2 of FIG. 12. At a step S3, in-vehicle information terminal 20 confirms whether the NPM corresponding vocal read out text file is included in the received information. It is noted that the determination of whether the received information is the NPM corresponding read out text file is carried out in accordance with the above-described determination condition based on the presence or absence of the description on the header tag (#!npm) of the text file of the speech contents and the property information thereof.

If NPM corresponding text file is not included (No), the routine goes to a step S6. At step S6, on-vehicle information terminal 20 determines whether the information is reproduced. That is to say, together with the image information displayed on display 26 via image reproducing device 25, a vocal information is produced from speaker 23 via voice synthesizer 22. At this time, the text to be read out not corresponding to NPM is carried out by means of voice synthesizer 22 for NPM non-correspondent text sentence.

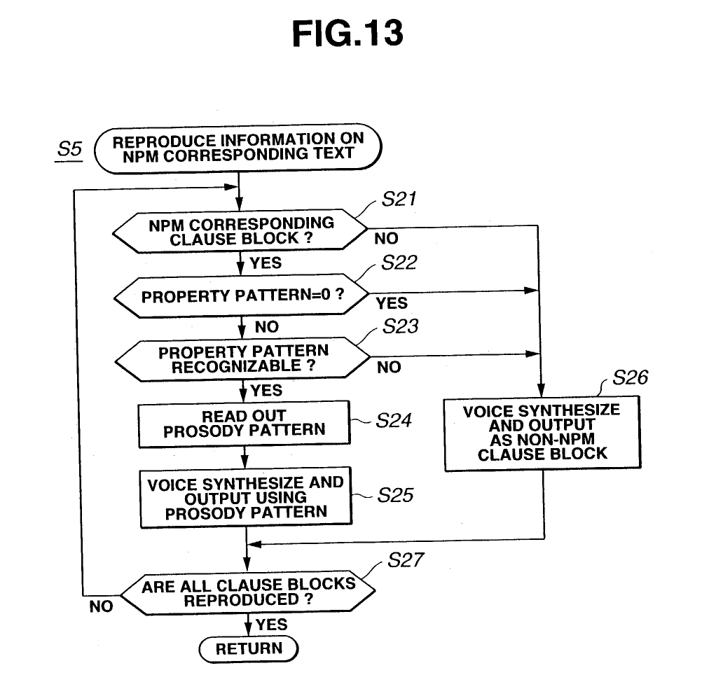

On the other hand, in a case where the NPM corresponding text file is included in the received information, the routine goes to a step S4. At step S4, the information other than NPM corresponding text file is reproduced. That is to say, together with the image information displayed on display 26 via image producing apparatus 25 and the information such as music is broadcast from speaker 23 via voice synthesizer 22. Next, at a step S5, a subroutine shown in FIG. 13 is executed to carry out information reproduction of the NPM corresponding text file It is noted that, for explanation conveniences, the information reproduction other than the NPM corresponding text file is carried out and, next, the read out (speech) of the NPM corresponding text file is carried out. However, these operations can be parallel and may be executed simultaneously.

At a step S21 shown in FIG. 13, in-vehicle information terminal 20 determines whether the first clause block of the data portion in the NPM corresponding text file is the NPM clause block. If the NPM corresponding clause tag (#npm) is described at the head of the block, the routine goes to a step S22. If the NPM corresponding clause tag (#npm) is not described, the routine goes to a step S26 determining that this clause is the NPM non-corresponding clause block.

At a step S22, in-vehicle information terminal 20 confirms whether the property of clause pattern No. 0 (pattern=0) in the property information of the clause block. Since the speech prosody pattern corresponding to clause pattern No. 0 is not present, in-vehicle information terminal 20 determines that the clause pattern No. 0 is the NPM non-corresponding clause block and the routine goes to a step S26.

If the clause portion No. 0 is not described, the routine goes to a step S23 to confirm whether the clause pattern No. described in the property information can be recognized, namely, to determine whether the speech prosody pattern corresponding to the described clause pattern No. is stored into the memory 24. If the speech prosody pattern corresponding to the clause pattern No. is not stored into memory 24, the clause block is determined to be NPM non-correspondence clause block and the routine goes to step S26. At step S26, in-vehicle information terminal 20 performs a vocal synthesis of an NPM non-corresponding clause block through voice synthesizer 22, carries out the text vocal read out of NPM non-corresponding without use of the speech prosody pattern, and broadcasts it through speaker 23.

On the other hand, if in-vehicle information terminal 20 determines that the text file received in the NPM corresponding clause block, the routine goes to a step S24. The speed prosody pattern corresponding to clause block No. described in the property information is read from memory 24. At the next step S25, voice synthesizer 22 uses the speech prosody pattern to vocally synthesize NPM corresponding clause block, carries out the text vocal read-out (speech) corresponding to NPM, and broadcasts it through speaker 23. At step S25, voice synthesizer 22 uses the speech prosody pattern to vocally synthesize NPM corresponding clause block and carries out the text vocal read out corresponding to NPM to broadcast it through speaker 23. Then, at a step S27, in-vehicle information terminal 20 confirms whether the reproduction of all clause blocks included in the NPM corresponding text file has been completed. If a non-reproduced clause block is left (No), the routine goes to a step S27. Then, the above-described procedure is repeated. If the reproduction of all clause blocks is completed, the program shown in FIG. 13 is returned to a main program shown in FIG. 12.

Since, in the embodiment described above, the information providing system in which various information including the text sentence read out from information center 10 to in-vehicle information terminal 20 is provided, information center 10 patternizes these clauses and stores them into memory 14. In a case where the clause pattern is included into the vocal read out (speech) text sentence, information center 10 specifies the clause pattern. Then, in-vehicle information terminal 20 stores the vocal prosody pattern for the clause pattern, reads the speed prosody pattern corresponding to the clause pattern specified by information center 10, and carries out the read out of the text sentence in the speech sound in accordance with the speech prosody pattern. Hence, the text to speech apparatus which is capable of reading out the text in the national intonation can be achieved.

In addition, since, in the above-described embodiment, each clause constituted by the variable phase replaceable for the arbitrary phrase and the common fixed phrase other than the variable phase is patternized, the patterns applicable to many clauses can be prepared so that the number of clause patterns can be reduced. In addition, a burden of a microcomputer installed in information center 10 which implements the text speech process can be relieved and its processing speed can be increased.

In the embodiment described above, information center 10 specifies whether the read out (speech) using the speech prosody pattern should be carried out for each clause block of the speech text sentence and, on the other hand, in-vehicle information terminal 20 carries out the speech (the vocal read out) using the speech prosody pattern for each clause block not specified from information center 10. Hence, the vocal read out (speech) of the text sentence can usually be carried out even if, in the text document to be spoken (to be read out), one or more clause blocks which includes the clause pattern or clause patterns is mixed with one or more clause blocks which does not include any clause pattern.

Furthermore, in the above-described embodiment, even in a case where the speech prosody pattern corresponding to one of the clause patterns which is specified by information center 10 is not stored in-vehicle information terminal 20, the vocal read out (speech) without use of the speech prosody pattern is carried out. Hence, even if a new clause pattern which cannot be recognized by in-vehicle information terminal 20 is specified by information center 10, the speech of the corresponding text document can be carried out. Irrespective of a version of speech prosody pattern memory 24 in each in-vehicle information terminal 20, a version up of the clause pattern memory of information center 10 can be carried out.

The entire contents of Japanese Patent Application No. 2001-389894(filed in Japan on Dec. 21, 2001) are herein incorporated by reference. The scope of the invention is defined with reference to the following claims.

What is claimed is:

1. A text to speech apparatus, comprising;
a first memory section in which a plurality of defined clause patterns are stored;
a second memory section in which a plurality of speech prosody patterns are stored, each speech prosody pattern being preset to correspond to one of the defined clause patterns and to reproduce the corresponding one of the defined clause patterns in a natural intonation speech sound; and
a text speech section that carries out a read out of at least one text sentence in accordance with one of the speech prosody patterns which corresponds to one of the defined clause patterns when at least the one of the defined clause patterns is present in the text sentence to be read out.

2. A text to speech apparatus as claimed in claim 1, wherein each defined clause pattern stored in the first memory section comprises a clause constituted by a variable phrase replaceable with an arbitrary phrase and a common fixed phrase other than the variable phrase.

3. A text to speech apparatus as claimed in claim 1, wherein the text sentence to be read out is a sentence expressing a predetermined speech sound content.

4. A text to speech apparatus as claimed in claim 3, wherein each clause pattern stored in the first memory section is a clause having a predetermined high frequency in use extracted from the sentence expressing the predetermined speech sound content.

5. A text to speech apparatus as claimed in claim 3, wherein the predetermined speech sound content is a weather forecast information.

6. A text to speech apparatus as claimed in claim 3, wherein the predetermined speech sound content is a road traffic information.

7. A text to speech apparatus as claimed in claim 3, wherein the predetermined speech sound content is an information on a best time to see red leaves of autumn.

8. A text to speech apparatus as claimed in claim 3, wherein the predetermined speech sound content is an information on a ski ground condition.

9. A text to speech apparatus as claimed in claim 1, wherein the first memory section is provided within an information center, the information center specifying the one of the defined clause patterns stored in the first memory section in a case where at least the one of the defined clause patterns is included in the text sentence to be read out and transmitting the text sentence to at least one information terminal and wherein the second memory section and the text speech section are provided within the information terminal, the information center and the information terminal constituting an information providing system.

10. A text to speech apparatus as claimed in claim 9, wherein the text sentence is constituted by a plurality of clause blocks and the information center, for each clause block of the text sentence to be readout, specifies whether the read out of the corresponding one of the clause block should be carried out using the speech prosody pattern and the information terminal carries out the read out of the corresponding clause block specified by the information center using the speech prosody pattern and carries out the read out of the corresponding one of the clause blocks of the text sentence unspecified by the information center without use of the speech prosody pattern.

11. A text to speech apparatus as claimed in claim 10, wherein the information terminal carries out the read out of the corresponding one of the clause blocks constituting the text sentence in accordance with the corresponding one of the speech prosody patterns stored in the second memory section in a case where one of the clause blocks of the text sentence specified by the information center corresponds to one of the defined clause patterns and carries out the read out of the corresponding one of the clause blocks constituting the text sentence without use of any speech prosody pattern in a case where one of the clause blocks of the text sentence specified by the information center corresponds to one of the defined clause patterns and the corresponding one of the speech prosody pattern is not stored in the second memory section.

12. A text to speech apparatus as claimed in claim 9, wherein the information terminal comprises at least one of a PDA portable by a user and in-vehicle information terminal which is mounted in an automotive vehicle.

13. An information providing system, comprising:
an information center that transmits various information including at least one text sentence to be read out, the information center including a first memory section in which a plurality of defined clause patterns are stored and specifying one of the defined clause patterns stored in the first memory section in a case where at least the one of the defined clause patterns is included in the text sentence to be read out; and
at least one information terminal that receives the various information including the text sentence from the information terminal, the information terminal including: a second memory section in which a plurality of speech prosody patterns are stored, each speech prosody pattern being preset to correspond to one of the defined clause patterns and to reproduce the corresponding one of the defined clause patterns in a natural intonation speech sound; and a text speech section that carries out a read out of at least one text sentence in accordance with one of the speech prosody patterns when at least the one of the defined clause patterns is present in the text sentence received therein to be read out.

14. An information providing system as claimed in claim 13, wherein each defined clause pattern stored in the first memory section comprises a clause constituted by a variable phrase replaceable with an arbitrary phrase and a common fixed phrase other than the variable phrase.

15. An information providing system as claimed in claim 13, wherein the text sentence is constituted by a plurality of clause blocks of the defined clause patterns and undefined clause patterns and the information center, for each clause block of the text sentence to be read out, specifies whether the read out of the corresponding one of the defined clause patterns should be carried out using the speech prosody pattern and the information terminal carries out the read out of the clause block specified from the information center using the speech prosody pattern and carries out the read out of any of the clause blocks unspecified by the information center without use of the speech prosody pattern.

16. An information system as claimed in claim 15, wherein the information terminal carries out the read out of the corresponding one of the clause blocks constituting the text sentence in accordance with the corresponding one of the speech prosody patterns stored in the second memory section in a case where one of the clause blocks of the text sentence specified by the information center corresponds to one of the defined clause patterns and carries out the read out of the corresponding one of the clause blocks constituting the text sentence without use of any speech prosody pattern in a case where one of the clause blocks of the text sentence specified by the information center corresponds to one of the defined clause patterns and the corresponding one of the speech prosody pattern is not stored in the second memory section.

17. An information providing system as claimed in claim 9, wherein the information terminal comprises at least one of a PDA portable by a user and in-vehicle information terminal which is mounted in an automotive vehicle.

18. An information providing system as claimed in claim 9, wherein the information center generates and transmits text files of predetermined speech contents to be read out to the information terminal, each text file including a header and a data, the header describing a header tag representing whether the corresponding text file is an NPM corresponding read out text having at least the speech prosody pattern and a property information and the data being constituted by a plurality of clause blocks, each clause block describing a clause tag representing whether the corresponding clause block corresponds to the defined clause patterns, another property information, and the clause data.

19. A text to speech apparatus, comprising;
first memory means for storing a plurality of defined clause patterns therein;
second memory means for storing a plurality of speech prosody patterns, each speech prosody pattern being preset to correspond to one of the defined clause patterns and to reproduce the corresponding one of the defined clause patterns in a natural intonation speech sound; and
text speech means for carrying out a read out of at least one text sentence in accordance with one of the speech prosody patterns which corresponds to one of the defined clause patterns when at least the one of the defined clause patterns is present in the text sentence to be read out.

20. A text to speech method, comprising;
storing a plurality of defined clause patterns;
storing a plurality of speech prosody patterns, each speech prosody pattern being preset to correspond to one of the defined clause patterns and to reproduce the corresponding one of the defined clause patterns in a natural intonation speech sound; and
carrying out a read out of at least one text sentence in accordance with one of the speech prosody patterns which corresponds to one of the defined clause patterns when at least the one of the defined clause patterns is present in the text sentence to be read out.
